(19) United States
(12) Patent Application Publication
(10) Pub. No.: US 2015/0046086 A1
(43) Pub. Date: Feb. 12, 2015

(54) REAL-TIME SPATIAL PATH COMPARISON

(71) Applicant: INTERNATIONAL BUSINESS MACHINES CORPORATION, Armonk, NY (US)

(72) Inventor: Kirk J. Krauss, Los Gatos, CA (US)

(21) Appl. No.: 14/491,426

(22) Filed: Sep. 19, 2014

Related U.S. Application Data
(63) Continuation of application No. 13/798,314, filed on Mar. 13, 2013.

(51) Int. Cl. G01B 21/04

(52) U.S. Cl. CPC G01B 21/04
USPC 701/519

(57) ABSTRACT

Methods for processing motion paths for physical entities. For each physical entity among several physical entities, several representations are received of positions of the physical entity. In response to detecting that a number of physical entities among the physical entities traverse a similar motion path, a path record is generated, which represents the motion path traversed by the number of physical entities.

### BACKGROUND

The present invention relates to data analysis, and more specifically, to analysis of spatial events. Entity analytics products perform entity analytics by associating entities (such as ships) with their features (such as loads) and feature elements (such as items and tonnages). Entity analytics products further allow entities to be associated with space and time data. For example, some entity analytics products use an entity feature known as a SpaceTimeBox (STB). An STB reflects a spatial region and a time interval, at a specific density. Any spatial event, that is, any point in spacetime, can be assigned to an STB. When an entity, such as a ship, is associated with an STB feature, other entities can be compared with it and exactly matched to that ship's spatial location at a certain time at the granularity defined by the STB's density. The STB density is configurable, as are parameters that allow for filtering of STBs in various conditions. The STB functionality provides spatial reasoning capabilities for advanced entity resolution, relationship awareness, and insight/relevance detection.

Motion processing can rely on quantization of space and time, for example, by using STBs for space and time quantization. The motion of entities with respect to STBs can be used to detect specific entity behavior, in real time, which can be published to downstream analytic applications.

### SUMMARY

According to one aspect of the present invention, techniques are provided for processing motion paths for physical entities. For each physical entity among several physical entities, several representations are received of positions of the physical entity. In response to detecting that a number of physical entities among the physical entities traverse a similar motion path, a path record is generated, which represents the motion path traversed by the number of physical entities.

According to another aspect of the present invention, techniques are provided for detecting motion path outliers for physical entities. For each physical entity among several physical entities, several representations of positions of the physical entity are received. In response to detecting that a physical entity among the physical entities traverses a motion path that is different from a motion path traversed by a majority of the physical entities, a path record is generated, which represents the different motion path traversed by the first different physical entity

The details of one or more embodiments of the invention are set forth in the accompanying drawings and the description below. Other features and advantages of the invention will be apparent from the description and drawings, and from the claims.

### BRIEF DESCRIPTION OF THE SEVERAL VIEWS OF THE DRAWINGS

FIG. 1 is a schematic block diagram showing a system for motion processing in accordance with one embodiment.

FIG. 2 is a schematic block diagram showing a computing node (10) of FIG. 1 in accordance with one embodiment.

FIG. 3 is a flowchart showing a process for detecting paths in accordance with one embodiment.

FIG. 4 is a flowchart showing a process for deleting expired events in accordance with one embodiment.

FIGS. 5-9 are schematic illustrations of grids of STBs and how paths of entities can be detected in these grids, in accordance with various embodiments.

FIG. 10 is a flowchart showing a more detailed view of step 321 of FIG. 3, in accordance with one embodiment.

Like reference symbols in the various drawings indicate like elements.

### DETAILED DESCRIPTION

### Overview

The various embodiments described herein pertain to techniques for motion processing, which can compare sets of spatial regions (e.g., STBs) accumulated over time, to identify life arcs (i.e., paths through space traversed by entities) and outliers to the life arcs (i.e., entities that follow alternate paths).

Using techniques in accordance with various embodiments, the following conditions, among others, can be detected and reported:
1. Spatial life arcs that many entities commonly traverse.
2. Outliers, conditions where entities traverse unexpected paths or trajectories (i.e., disparate spatial life arcs).

In one embodiment specific to geospatial motion processing, STBs can be created by routines implemented, for example, as a plugin module in the entity analytics product, based on an input geospatial region and time interval, by using a geohash public domain geospatial-quantizing algorithm, along with a simple time-quantizing algorithm. The routines concatenate the algorithms' outputs to form an STB key. In one embodiment, the algorithms work as follows:
1. The geohash geospatial-quantizing algorithm encodes a pair of latitude and longitude coordinate values into an alphanumeric string. Two entities that reside in the same STB will thus have comparable geohash strings. A user can configure the string length to set the spatial density of STBs. A user also can configure a single input coordinate to be assigned to multiple STBs of varying spatial density.
2. The time-quantizing algorithm converts a datetime value into an interval whose “upper” and “lower” boundaries conform to set points usable for later datetime comparison. Two entities that reside in the same STB will thus have comparable datetime intervals. The entity analytics product uses the “lower” boundary of the interval when generalizing a datetime. In some embodiments, a user can configure the time interval density of STBs. In some embodiments, a user also can apply multiple time densities over multiple spatial densities, for a single set of spacetime coordinates.

By having such a flexible configurability of time and space generalization, for use together with exact-match comparison of STBs for the purpose of context accumulation and relevance detection, it is possible to detect, among other things, geospatial life arcs that many entities commonly traverse, as well as outliers to the geospatial life arcs, as described above.

While the paths will be described herein by way of example as sets of quantized spacetime regions (e.g. STBs), it should be noted that STBs are not a required aspect of the inventive concepts described herein, and that other embodiments may very well use other forms of spacetime quantization, or no spacetime quantization at all. For example, some embodiments may use bit vectors to encode spatial coordinates. In some embodiments, time can be quantized based on milliseconds that have passed since a particular moment, or by storing short integer values that represent the year, month, day, hour, minute, second, and millisecond, respectively.

The various embodiments of the motion processing application described herein will be referred to as a “path detector.” However, it should be realized that the path detector can be used both to recognize common paths traversed by multiple entities and to detect outlying entities that traverse alternate routes (i.e., off the recognized paths), as mentioned above.

In one embodiment, the path detector works, in short, as follows. When a qualifying number of qualifying entities is found to traverse a similar path for the first time, the path detector produces a path record for those entities. The qualifiers for determining what is a qualifying number and what is a qualifying entity are configurable. For example, the configuration can include counting the number of tracked entities of a given type and/or observed from a given data source, or so on. Given a count of these certain entities, the qualifying number might be determined based on a percentage, so that, say, at least 20% of these entities must traverse a similar path in order for the path detector to produce a path record.

The path record can include a set of STBs (or different form of specific spatiotemporal descriptors) that represent the common path traversed by the entities. When a path has been determined to be associated with a specific type of qualifying entity, and yet a certain qualifying entity is observed to traverse an alternate path, the path detector can produce an outlier record for the entity traversing the alternate path, optionally including a set of STBs (or other specific spatiotemporal descriptors) representing the alternate path traversed by that entity.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowcharts and/or block diagram block or blocks.

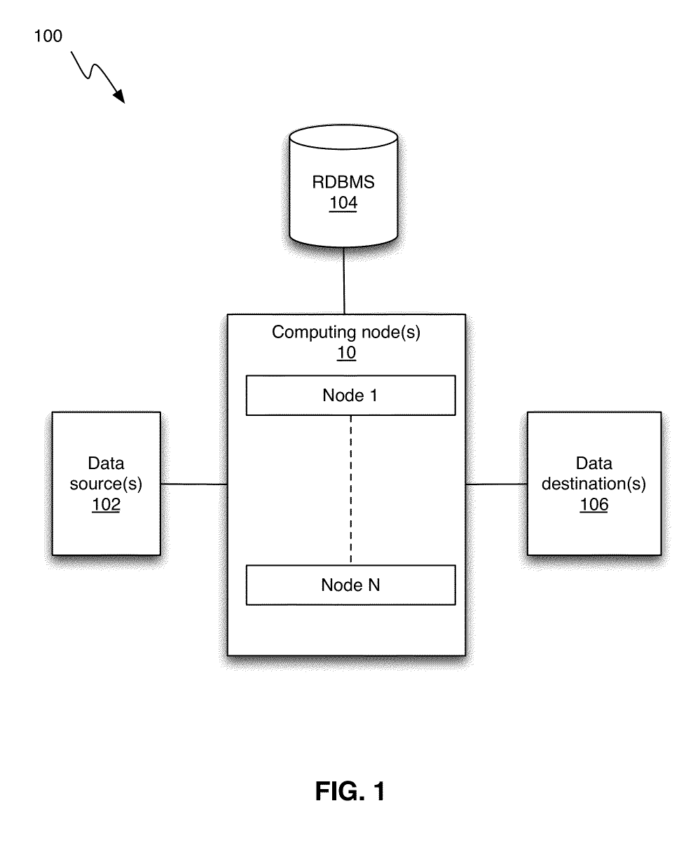

Referring now to FIG. 1, a schematic of an example of a system (100) for motion processing in accordance with one embodiment is shown. As can be seen in FIG. 1, the system includes one or more computing nodes (10), which collaborate as will be described in further detail below to process data received in inbound messages from one or more data sources (102). Each node (10) can be an independent computer or processor, which contributes to a larger task of performing the techniques described herein, for a given set of entities and events specified by the inbound messages from the data source(s) (102). One example of a data source is the Automatic Identification System (AIS), which is an automatic tracking system used on oceangoing vessels, and by vessel traffic services (VTS) for identifying and locating vessels by electronically exchanging data amongst vessels, AIS base stations, and satellites. It should be realized, though, that this is merely one example and that people having ordinary skill in the art can easily come up with other alternatives of data sources that are suitable for use in accordance with the techniques presented herein.

The nodes (10) are connected to a shared Relational Database Management System (RDBMS) (104), which can collect data from the nodes (10) and provide data to the nodes (10). The shared RDBMS (104) is only one example of a suitable basis for entity analytics processing and/or motion processing and is not intended to suggest any limitation as to the scope of use or functionality of embodiments of the invention described herein. The RDBMS (104) can contain, for example, data about data sources, observations, entities, features, and elements. A data source is usually a database table, query or extract from a system of record. An observation occurs when a record is added, changed, or deleted in a data source. An entity is a usually particular type of record in a database table like a customer master record or a transaction record. A feature is a particular piece of information about an entity. Sometimes a table contains multiple fields that in fact describe the same thing. A feature may be represented by a group of fields that all describe the same thing. Many fields represent features all by themselves, but some can be grouped into a higher level. For instance, names and mailing addresses usually contain multiple fields or elements. An element is a further breakdown of a feature, such as the postal code that forms part of a typical address, and is usually represented by a field in a table.

By collecting this type of information in the shared RDBMS (104), the computing nodes (10) can work together to compare entities and features against each other and resolve various types of entities and relationships, as will be described in further detail below. The relationship contexts for the entities can be provided in an outbound message to one or more data destination(s) (106), such as an entity analytics engine (and its data supply), which can be defined by a user. However, it should be realized, though, that this is merely one example and that persons having ordinary skill in the art can easily come up with other alternatives of data destinations that are suitable for use in accordance with the techniques presented herein. For example, other data destinations for the path detector can include graphical modeling tools in which physical paths are represented in various views, machine learning systems in which paths are associated with other input, e.g. for automated decision-making purposes, mapping utilities, automated navigation advisers for travelers (like the dashboard-mounted kind, or for hikers), systems for plotting the motion of astronomical objects, and systems for the study of particle physics, just to mention a few examples. It should be realized that while only one data source (102), one RDBMS (104) and one data destination (106) are illustrated in FIG. 1, in a real-life scenario, there may be multiple data sources (102), multiple (or zero) RDBMSs (104) and multiple data destinations (106) included in the motion processing system (100).

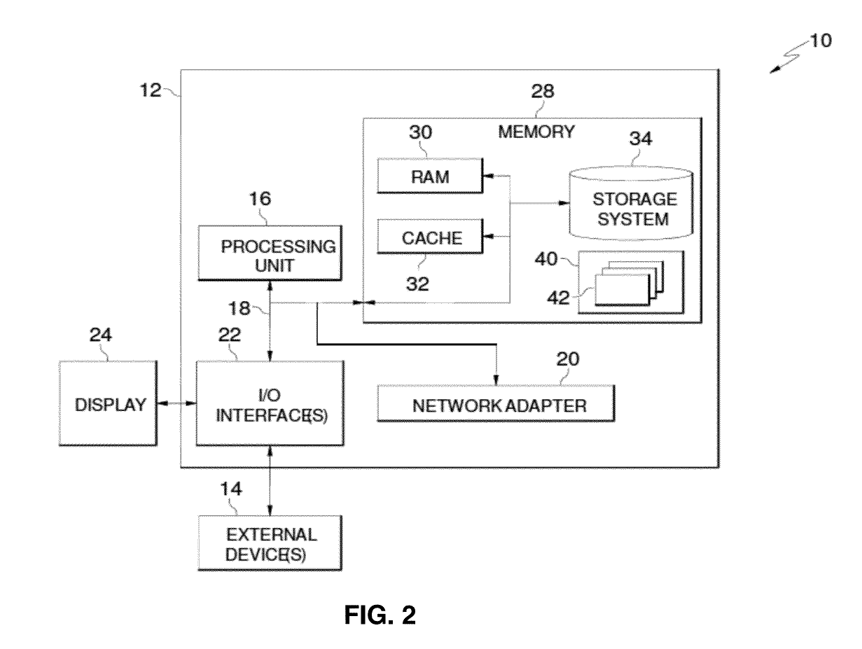

Referring now to FIG. 2, a schematic example of a computing node (10) is shown. The computing node (10) is only one example of a suitable computing node and is not intended to suggest any limitation as to the scope of use or functionality of embodiments of the invention described herein. Regardless, the computing node (10) is capable of being implemented and/or performing any of the functionality set forth herein. In the computing node (10) there is a computing device (12). Examples of well-known computing devices include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed computing environments that include any of the above systems or devices, and the like.

The computing device (12) may be described in the general context of computer system executable instructions, such as program modules, being executed by a computer system. Generally, program modules may include routines, programs, objects, components, logic, data structures, and so on that perform particular tasks or implement particular abstract data types. The computing device (12) may be practiced in distributed cloud computing environments where tasks are performed by remote processing devices that are linked through a communications network. In a distributed cloud-computing environment, program modules may be located in both local and remote computer system storage media including memory storage devices.

As shown in FIG. 2, the computing device (12) in the computing node (10) is shown in the form of a general-purpose computing device. The components of the computing device (12) may include, but are not limited to, one or more processors or processing units (16), a system memory (28), and a bus (18) that couples various system components including system memory (28) to the processor (16).

The bus (18) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Peripheral Component Interconnect (PCI) bus, PCI Express bus, InfiniBand bus, HyperTransport bus, and Serial ATA (SATA) bus.

The computing device (12) typically includes a variety of computer system readable media. Such media may be any available media that is accessible by the computing device (12), and it includes both volatile and non-volatile media, and removable and non-removable media.

The system memory (28) can include computer system readable media in the form of volatile memory, such as random access memory (RAM) 30 and/or cache memory 32. The computing device (12) may further include other removable/non-removable, volatile/non-volatile computer system storage media. By way of example only, the storage system (34) can be provided for reading from and writing to a non-removable, non-volatile magnetic medium (not shown and typically called a “hard drive”). Although not shown, a magnetic disk drive for reading from and writing to a removable, non-volatile storage medium (e.g., a “USB flash drive”), and an optical disk drive for reading from or writing to a removable, non-volatile optical disk such as a CD-ROM, DVD-ROM or other optical media can be provided. In such instances, each can be connected to the bus (18) by one or more data media interfaces. As will be further depicted and described below, the memory (28) may include at least one program product having a set (e.g., at least one) of program modules that are configured to carry out the functions of embodiments of the invention.

The program/utility (40), having a set (at least one) of program modules (42), may be stored in the memory (28) by way of example, and not limitation, as well as an operating system, one or more application programs, other program modules, and program data. Each of the operating system, one or more application programs, other program modules, and program data or some combination thereof, may include an implementation of a networking environment. The program modules (42) generally carry out the functions and/or methodologies of embodiments of the invention as described herein. The computing device (12) may also communicate with one or more external devices (14) such as a keyboard, a pointing device, a display 24, etc.; one or more devices that enable a user to interact with the computing device (12); and/or any devices (e.g., network card, modem, etc.) that enable the computing device (12) to communicate with one or more other computing devices. Such communication can occur via Input/Output (I/O) interfaces (22). Still yet, the computing device (12) can communicate with one or more networks such as a local area network (LAN), a general wide area network (WAN), and/or a public network (e.g., the Internet) via the network adapter (20). As depicted, the network adapter (20) communicates with the other components of the computing device (12) via the bus (18). It should be understood that although not shown, other hardware and/or software components could be used in conjunction with computer system/server (12). Examples, include, but are not limited to: microcode, device drivers, redundant processing units, external disk drive arrays, RAID systems, tape drives, and data archival storage systems, etc.

As was described above, a path exists when motion data associated with a set of entities matches, or more particularly when a series of positional data observations associated with a set of entities is observed to encompass correlating sets of spatial regions. For example, a qualifying threshold can be used to define a path width, within which positional data observations for entities must be located for the entities to form a correlating set. An outlier, on the other hand, is an entity that traverses a path that is different from most other similar entities (e.g., entities that are all of a given type and/or observed from a given data source, and so on). As was described above, a path detector application in accordance with various embodiments of the invention can recognize and indicate both paths and outliers. It can run as a Streams operator or as a standalone executable that can provide output, encoded in the Extended Markup Language (XML) or otherwise, to the entity analytics applications.

The term “Streams operator” as used herein refers to a software component designed for distributed computing use and coded for use with the InfoSphere Streams product, also available from International Business Machines Corporation, which has its own programming language, Streams Processing Language (SPL). The term “standalone executable” as used herein refers to a typical software application, or applet, i.e. for Windows, Linux, or Solaris for example, implementable in native, Java, or managed code, or as a script, which can run entirely on its own and produce the path and/or outlier records for any purpose whatsoever.

While XML is rapidly becoming a standard for tagged data transfer between applications and/or components, it is noted that there are also several other forms in which output can be provided. For example, one alternative is tagless storage, such as in-memory data structures that are agreed on between applications or components and shared through means such as named pipes, shared memory, queues, on-disk files, and so on. Another alternative involves writing data to a database (using SQL encodings, for example) and reading the data back into other applications or components. Yet another alternative involves writing a custom data transfer protocol. As can be seen, many variations of data exchange mechanisms can be envisioned by those having ordinary skill in the art.

### In-Memory Entity and Event Tracking

The various embodiments of the path detector can use in-memory entity and event tracking to detect paths and outliers with maximum efficiency. In one embodiment, the path detector's in-memory event data is not shared across processes. Therefore, incoming motion data for a particular entity must be consistently passed to a particular node tracking that entity. One simple scheme involves always passing the same entity identifier to the same node. Nodes, as used herein, refer to independent computers or processors, each of which contributes to a larger task of performing the techniques described herein, for a given set of entities and events. A group of computers (i.e. nodes) can participate in a path detection job if the workload can be reasonably distributed among the participating computers.

In deploying the path detector, a user can arrange for observed physical entities to be tracked, and for the path detection methods described here in to be performed, by any of several processing nodes. For example, one computer can process all incoming records, then farm out individual path detection tasks to one of N other computers (that is, N processing nodes). Based on a numeric entity or observation identifier, a decision can be made as to which node among the N nodes will process a given task. In some embodiments, this decision can be as simple as taking the input identifier modulo N.

In some embodiments, the path detector's in-memory event data is volatile. That is, whenever the path detector is exited and restarted, any work-in-progress path or outlier reports can be lost. This means that stopping and re-starting the path detector may cause the system to miss reporting real paths and/or outliers. In order to reduce the risk of this happening, in some embodiments, some of the motion data history is replayed, for example, by going back 48 hours and replaying those motion records applicable to any node that is restarted.

Some embodiments of the path detector allow paths and outliers to be detected based on configurable time windows, or time horizons, whose durations have practical limits based on the number of entities and events that are tracked. Events can expire as the current time moves on past those time horizons, and the memory used for tracking expired events can be reclaimed. A user can set up horizons of varying durations by assigning tasks to multiple path detector processes for scalability. For example, one process might work on minute-based motion data to produce daily path and outlier records. These records could then be treated as events streamed to another process that might roll up to weekly or monthly path/outlier reports.

### The STB Path Configuration Data File

In some embodiments, a configuration data file or database table can associate input spatial events with a set of qualifying entity types, STB densities, time horizons, and qualifying values related to path and outlier recognition. Table 1 below shows an example of entries that can be included in a configuration file in one embodiment. It should be noted that any units or field names merely serve as examples and should not be construed as limiting the invention. Other names and/or units may also be used, as would be apparent to those of ordinary skill in the art.

TABLE 1

| | Data | |
|---|---|---|
| Field name | type | Notes |
| DSRC_CODE | alpha- | Data source providing |
| | numeric | eligible spatial events |
| ETYPE_CODE | alpha- | Entity type associated |
| | numeric | with eligible spatial |
| | | events |
| STB_NAME | alpha- | SpaceTimeBox name |
| | numeric | (precision indicator) |
| MAX_DUR | numeric | Maximum allowable |
| | | time interval for path |
| | | traversal |
| MAX_DUR_UOM | alpha- | Units of measure for |
| | numeric | maximum duration |
| | | interval |
| PATH_WIDTH_METERS | numeric | Range beyond which |
| | | entities are outliers |
| ENTITIES_PER_PATH_PERCENT | numeric | Percentage of entities |
| | | that must traverse a |
| | | path to qualify it |
| MAX_OUTLIERS_PERCENT | numeric | Maximum allowable |
| | | percentage of entities |
| | | that may be outliers |

Each entry in the configuration file of Table 1 can associate a data source and an entity type with a time, and with path-recognition and outlier-recognition parameters, as follows.

DSRC_CODE—Data source code: An identifier that corresponds to the data source for which a recognized path or outlier may be indicated.

ETYPE_CODE—Entity type code: An identifier that corresponds to an entity type for which a recognized path or outlier may be indicated.

STB_NAME—SpaceTimeBox name: An identifier for an STB type defined in a master list. The actual names can be arbitrary. Default names describing available STB densities can be provided to improve human readability.

MAX_DUR—Maximum duration: A numeric value representing the maximum time interval after which an observed event becomes irrelevant to further path or outlier recognition.

MAX_DUR_UOM—Maximum duration units of measure: An identifier for the units of measure applicable to the MAX_DUR value. Acceptable identifiers can include, for example, YEAR, MONTH, DAY, HOUR, MIN, SEC, and MS.

PATH_WIDTH_METERS—Path width in meters: A numeric value representing the extent, in meters, of a path beyond which the path detector may consider entities as outliers or as traversing an alternate path.

ENTITIES_PER_PATH_PERCENT—Percentage of entities that must follow a common path to qualify it as a detected path: A numeric value representing a percentage of entities associated with a set of STBs in order to qualify it as a path. This percentage also determines the maximum number of detectable paths, i.e. (100/this percentage), with no remainder.

MAX_OUTLIERS_PERCENT—Percentage of entities that may be outliers: A numeric value representing a percentage of entities not associated with any recorded path. The path detector can refrain from reporting outliers if more than this percentage of entities would otherwise qualify as outliers.

In an embodiment suitable for detecting the paths of oceangoing vessels for analysis via an entity analytics product, geospatial positional data collected by the path detector can be sent to the entity analytics product as an Extended Markup Language (XML) message. The following is an example of an XML message specifying an observation of an entity that has a latitude, longitude and time associated with it.

```
<UMF_DOC>
  Input document tag
  <OBS>
    Observation tag
```

```
<DSRC_CODE>TEST</DSRC_CODE>
  Data describing a data source and observation
<DSRC_ACTION>A</DSRC_ACTION>
<OBS_SRC_KEY>
  4779950171|2010-08-12 15:24:00
</ OBS_SRC_KEY>
  <SRC_CREATE_DATE>2010-08-12 15:24:00
  </SRC_CREATE_DATE>
  <OBS_ENT>
    Observed entity tag
```

```
<ETYPE_CODE>VESSEL</ETYPE_CODE>
  Data describing an entity
<ENT_SRC_KEY>477995071|2010-08-12 15:24:00
</ENT_SRC_KEY>
<ENT_SRC_DESC>477995071|2010-08-12 15:24:00
</ENT_SRC_DESC>
<OBS_FEAT>
  <FTYPE_CODE>MMSI_NUM</FTYPE_CODE>
    Data describing a feature
  <OBS_FELEM>
```

<FELEM_CODE>ID_NUM</FELEM_CODE>
Data describing a feature element
<FELEM_VALUE>477995071</FELEM_VALUE>

```
  </OBS_FELEM>
</OBS_FEAT>
<OBS_FEAT>
  <FTYPE_CODE>GEO_LOC</FTYPE_CODE>
    Geospatial data
  <OBS_FELEM>
```

<FELEM_CODE>LATITUDE</FELEM_CODE>
Latitude data
<FELEM_VALUE>22.28830167</FELEM_VALUE>

```
  </OBS_FELEM>
  <OBS_FELEM>
```

<FELEM_CODE>LONGITUDE</FELEM_CODE>
Longitude data
<FELEM_VALUE>114.1584</FELEM_VALUE>

```
  </OBS_FELEM>
  <OBS_FELEM>
```

<FELEM_CODE>TIME</FELEM_CODE>
Datetime data
<FELEM_VALUE>1999-12-31
00:00:00</FELEM_VALUE>

</OBS_FELEM>
</OBS_FEAT>

</OBS_ENT>
</OBS>

</UMF_DOC>

A similar XML message format can be used by the path detector to generalize a geospatial event. In some embodiments, geospatial quanta are stored and compared as bit vectors, for rapid evaluation of a set of geospatial quanta to which a given pair of latitude and longitude coordinates can be assigned. Such a method can be useful for the path detector to compare positional data and thus recognize path adherence. In other embodiments, algorithms such as Euclidean or Vincenty metrics can be used, which are well known to people having ordinary skill in the art of spatial mathematics and physics. These are means by which the presence of an entity within a path of the width specified via PATH_WIDTH_METERS can be determined mathematically.

The path detector can associate each tracked event with a tracked entity. For each tracked entity, the path detector can record an entity key and a most recently observed event. For rapid entity lookup and for efficient cleanup of expired tracked data, the path detector can track entities and events in a skiplist sorted by numeric entity keys. Skiplists are well known to those having ordinary skill in the art and are described, for example, in “Skip Lists: A Probabilistic Alternative to Balanced Trees” by William Pugh, Communication of the ACM, Volume 33, Number 6, June 1990. The skiplist data structure is unusually well suited to the problem at hand, because the skiplist can be treated as an ordinary linked list for the purpose of enabling a thread to efficiently walk through the entire set of tracked data looking for expired data to clean up. The skiplist also can be treated as an ordered list for the purpose of high-performance key-based lookup of a list element. The performance, when the skiplist is traversed for key comparison purposes, is comparable to that of a balanced search tree. Thus, skiplists are very useful in terms of achieving maximal scalability, performance and simplicity. It should, however, be realized that the path detector can alternatively be implemented using an actual balanced search tree or other suitable data structure. However, with such a data structure the cleanup thread would need to use a relatively sophisticated (and performance-limited) algorithm to search out expired data.

An event queue can be associated with each tracked entity. The event queues can be implemented as simple First-In-First-Out (FIFO) queues, such that the oldest events are always at the end of the queue for each entity. A queue cleanup thread can routinely walk the entity list and the associated event queues and deallocate the tracking structures associated with any events older than the maximum duration. The queue cleanup thread also can deallocate the tracking structures associated with any entities whose event queues have become entirely empty.

In an embodiment specific to geospatial data, for each observed entity, the path detector can track events associated with geohash values (or with bit vectors corresponding to the geohash values) extracted from the STBs designated in the STB path configuration data file. In some embodiments, the path detector considers any event accumulation that has exceeded the configured time horizon to be expired, and the path detector will generate no path record once the relevant events have expired. Rather, the path detector will deallocate the memory for those accumulated events.

In some embodiments, the path detector can track observed events for each tracked entity and can compare event queues for each tracked entity. Any two entities whose event queues each contain a series of sequential events, in which all events at corresponding positions of both sequences are all within PATH_WIDTH_METERS of one another, can be tagged as traversing a potential path. The path detector can recognize a path as such when the percentage of entities tagged as potentially traversing that path reaches the ENTITIES_PER_PATH_PERCENT value. When the path detector recognizes a path, it can generate a report. In that report, the path can be represented as a series of STBs. The report also can optionally list the entities that have traversed that path.

In some embodiments, the path detector can generalize the set of STBs that are associated with each quantum associated with the path. To do that, the path detector can average the central latitude and longitude coordinates of each STB that sequentially comprises the path and regenerate a series of generalized STBs based on those averages. The path detector can use this generalized series when detecting the recognized path. The path detector also can use this generalized series when reporting the recognized path.

In the path detector's memory space, paths that have been generalized, as described above, can be duplicated into memory designated for comparison with further incoming motion data. Further observations can then be compared to these generalized recognized paths stored in memory, for recognition of outliers. Once the path detector has established and stored these recognized paths, it can report any entities that do not traverse a recognized path. The path detector can skip this reporting if the percentage of tracked entities that do not traverse recognized paths is more than MAX_OUTLIERS_PERCENT.

In some embodiments, the path detector provides an option, based on an additional threshold configuration setting that allows for paths to vary over time. If, over time, more and more outliers occur along a path sufficiently near a recognized path, as determined by the threshold, then the path detector can modify that recognized path by rerunning the generalization routine described above against the events comprising the modified path.

When the path detector reports a recognized path or outlier, it can do so by passing data about the path or outlier into a downstream analytics application, via an encoding such as XML. The XML data can describe the path or outlier as an observed feature of the subject entity or entities, where the feature can be codified (e.g. using a feature type code such as STB_KEY and a usage type code of PATH or OUTLIER) to designate motion data for the entity as being associated with or disparate from a recognized path. The XML data also can associate the subject entity or entities with the sequence of spacetime quanta (e.g. STBs) that represent a recognized or outlying path. For example, the XML can include a set of feature elements whose codes are “EXPRESSION” and whose values reflect the sequence of STB keys corresponding to the spatial regions in which a recognized path may be indicated. When the path detector reports an outlier, it can report the outlier's path similarly.

The following is an example of a recognized path record via XML suitable for representing an observed feature to an entity analytics product:

<UMF_DOC>
Input document tag

```
  <OBS>
  Observation tag
    <DSRC_CODE>AIS</DSRC_CODE>
    Data describing a data source and observation
    <DSRC_ACTION>A</DSRC_ACTION>
    <OBS_SRC_KEY>477995071|2010-08-12 15:24:00
    </ OBS_SRC_KEY>
    <SRC_CREATE_DATE>2010-08-12 15:24:00
    </SRC_CREATE_DATE >
    <OBS_ENT>
    Observed entity tag
    <ETYPE_CODE>VESSEL</ETYPE_CODE>
    Data describing an entity
    <ENT_SRC_KEY>477995071|2010-08-12 15:24:00
    </ENT_SRC_KEY>
    <ENT_SRC_DESC>477995071|2010-08-12 15:24:00
    </ENT_SRC_DESC>
    <OBS_FEAT>
```

```
  <FTYPE_CODE>MMSI_NUM
  </FTYPE_CODE>
  Data describing a feature
  <OBS_FELEM>
  <FELEM_CODE>ID_NUM</FELEM_CODE>
  <FELEM_VALUE>477995071</FELEM_VALUE>
  </OBS_FELEM>
```

```
    </OBS_FEAT>
    <OBS_FEAT>
    <FTYPE_CODE>STB_KEY</FTYPE_CODE>
    Path feature data
    <UTYPE_CODE>PATH</UTYPE_CODE>
    <USED_FROM_DT>2010-08-12 14:24:00</
    USED_FROM_DT>
    <USED_THRU_DT>2010-08-12 15:24:00</
    USED_THRU_DT>
    <OBS_FELEM>
    Path feature element data
```

<FELEM_CODE>EXPRESSION</FELEM_CODE>
<FELEM_VALUE>GR1_GH4_1HOUR|xn73|2010-08-12
14:24:00
</FELEM_VALUE>

```
    </OBS_FELEM>
    <OBS_FELEM>
    Path feature element data
```

<FELEM_CODE>EXPRESSION</FELEM_CODE>
<FELEM_VALUE>GR1_GH4_1HOUR|xn72|2010-08-12
14:24:00
</FELEM_VALUE>

```
  </OBS_FELEM>
  <OBS_FELEM>
  Path feature element data
    <FELEM_CODE>EXPRESSION</FELEM_CODE>
    <FELEM_VALUE>GR1_GH4_1HOUR|xn71|2010-08-12
    14:24:00
    </FELEM_VALUE>
  </OBS_FELEM>
  <OBS_FELEM>
  Path feature element data
  <FELEM_CODE>EXPRESSION</FELEM_CODE>
  <FELEM_VALUE>GR1_GH4_1HOUR|xn72|2010-08-12
  14:24:00
  </FELEM_VALUE>
  </OBS_FELEM>
```

```
    </OBS_FEAT>
  </OBS_ENT>
</OBS>
</UMF_DOC>
```

In some embodiments, entities and events can be tracked via a first thread that monitors incoming real-time data. Whenever the first thread is not busy tracking incoming data, a second thread can walk the skiplist sequentially, cleaning up expired records (i.e., those records older than the MAX_DUR time horizon) and pausing in its walk whenever the first thread adds further incoming data to the list. Dedicating a thread to eliminate expired records by simply walking an ordered list repeatedly, allows the path detector to run with optimum scalability.

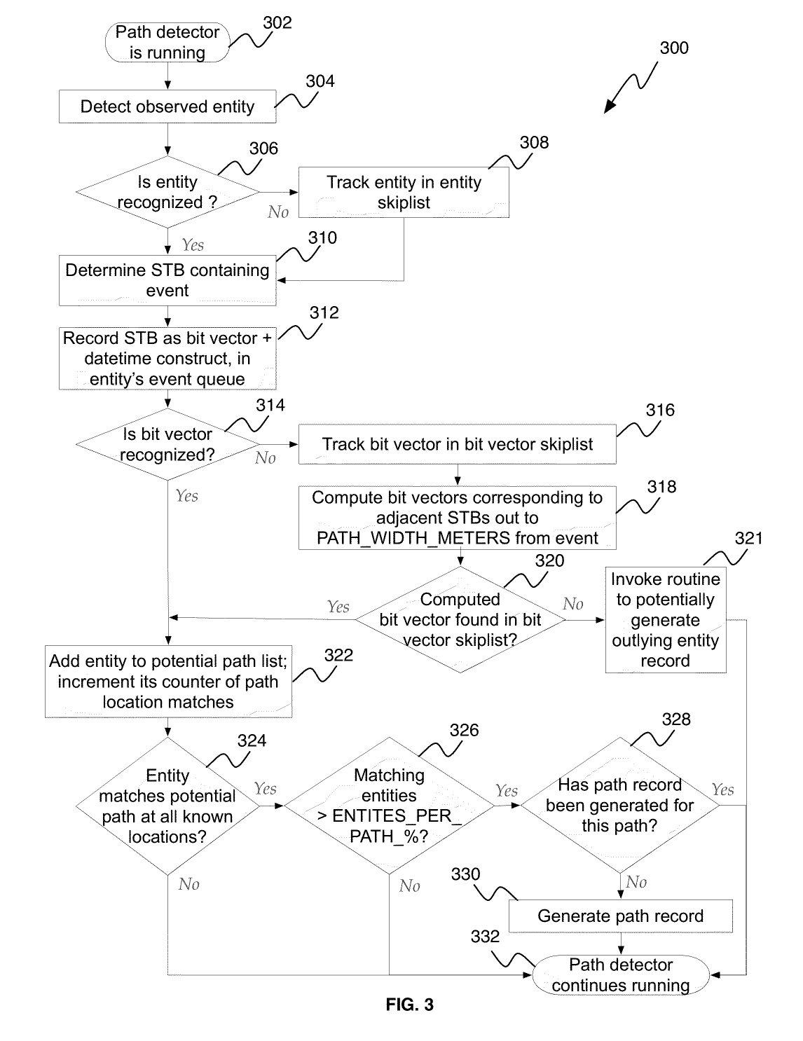

In order to further illustrate the various concepts of the various embodiments of the invention, some further examples will now be provided with reference to the drawings. FIG. 3 ties together some of the concepts described above, by showing a process (300) for detecting paths in accordance with one embodiment. The process (300) uses two skiplists: a bit vector skiplist, which contains entries that include references to an entity skiplist, and an entity skiplist, which contains corresponding entries referencing queued events that in turn reference the bit vector skiplist. As can be seen in FIG. 3, the process (300) starts by running the path detector (step 302). An observed entity is then detected (step 304). The process then determines whether the entity is recognized (step 306), by examining if the entity is found in the entity skiplist. If the entity is not found in the entity skiplist, the process starts tracking the entity in the entity skiplist (step 308). If the entity is found in the entity skiplist in step 306, or if a new skiplist entry was created in step 308, the process continues by determining a STB containing an event (step 310) reflecting the spatial location and time at which the entity has just been observed. The process records the STB as a bit vector and datetime construct in the entity's event queue (step 312).

Next, the process determines whether the bit vector is recognized (step 314), by examining if the bit vector is found in the bit vector skiplist. If the bit vector is not found in the bit vector skiplist, the process starts tracking the bit vector in the bit vector skiplist (step 316) and computes bit vectors corresponding to adjacent STBs out to PATH_WIDTH_METERS from the event (step 318). The process then examines if one of the computed bit vectors is found in the bit vector skiplist (step 320). If the entity is not found in the bit vector skiplist, the process continues to invoke a routine for potentially generating an outlying entity record (step 321). This routine will be described below with reference to FIG. 10. After completing the outlying record routine, the process continues to run the path detector (step 332).

If it is determined in step 314 that the bit vector is recognized, or if a computed bit vector is found in the bit vector skiplist in step 320, the process continues by adding the entity to a potential path list (step 322), and by incrementing the entity's counter of path location matches.

Next, it is determined whether the entity matches a potential path at all the locations (step 324) known to the path detector for this path. If entities are assumed to follow paths that do not overlap or meet, then determining whether the entity matches a potential path at all its known locations (e.g. STBs) can be as simple as comparing its counter of path location matches to one or more similar counters associated with other entities, or with a previously-generated path record, associated with locations traversed by the entity. Alternatively, determining whether the entity matches a potential path at all its known locations can include additional steps, such as tracking and comparing potential paths for each entity. Bit vector skiplist entries can be associated with both entities and their potential paths in an embodiment that includes such steps. Potential paths can be tracked as linked lists of references amongst entries in the bit vector skiplist, or in the same format as generated path records, or in any other suitable format. Potential paths can expire and can be cleaned up after their expiration.

For the sake of simplicity, no tracking, comparison, and cleanup steps involving potential paths are shown in the Figures. Such tracking and comparison steps can stand in place of the references to the counter for path location matches as shown in FIG. 3. In any case, the bit vector skiplist can be referenced to efficiently determine which other entities have traversed a particular location in which the entity is observed (e.g., these can include any other entities previously associated with the skiplist entry for the bit vector just recorded at step 312). Regardless of how the determination is made as to whether the entity matches a potential path on all its locations, if that determination is affirmatively made, the process continues by examining whether the number of matching entities is larger than the ENTITIES_PER_PATH_PERCENT value (step 326). If the percentage of matching entities is not larger than the ENTITIES_PER_PATH_PERCENT value, or if the entity does not match a potential path on all its locations, the process continues to run the path detector (step 332).

If the number of matching entities is larger than the ENTITIES_PER_PATH_PERCENT value the process continues by examining whether a path record has been generated for the path (step 328). If a path record has been generated, the process continues to run the path detector (step 332). If a path record has not been generated, the process generates a path record (step 330) and continues to run the path detector (step 332). Alternatively at step 330, if the path detector is tracking a path record that includes multiple locations but not the current observed location of the entity, and if the percentage of entities that have been observed at that location is larger than the ENTITIES_PER_PATH_PERCENT value, then the path detector updates that path record to include that location. In any case the process continues to run the path detector (step 332).

FIG. 10 shows a more detailed view of step 321 of FIG. 3 of a process for potentially generating an outlying entity record, in accordance with one embodiment. As can be seen in FIG. 10, when it is determined in step 320 of FIG. 3 that the computed bit vector is not found in the bit vector skiplist, the process checks whether the number of outlying entities is larger than the MAX_OUTLIERS_PERCENT defined by the user (step 1002). If there are too many outliers the process returns to step 332 of FIG. 3, as described above.

On the other hand, if it is determined in step 1002 that the number of outlying entities is not larger than the MAX_OUTLIERS_PERCENT defined by the user, then the process continues to determine whether an outlier record has been generated for the entity and location (step 1004). If there is an outlier record for the entity and location, the process returns to step 332 of FIG. 3, as described above.

On the other hand, if it is determined in step 1004 that there is no outlier record for the entity and location, then an outlier record is generated, which includes the entity's location (step 1006), and process returns to step 332 of FIG. 3, as described above.

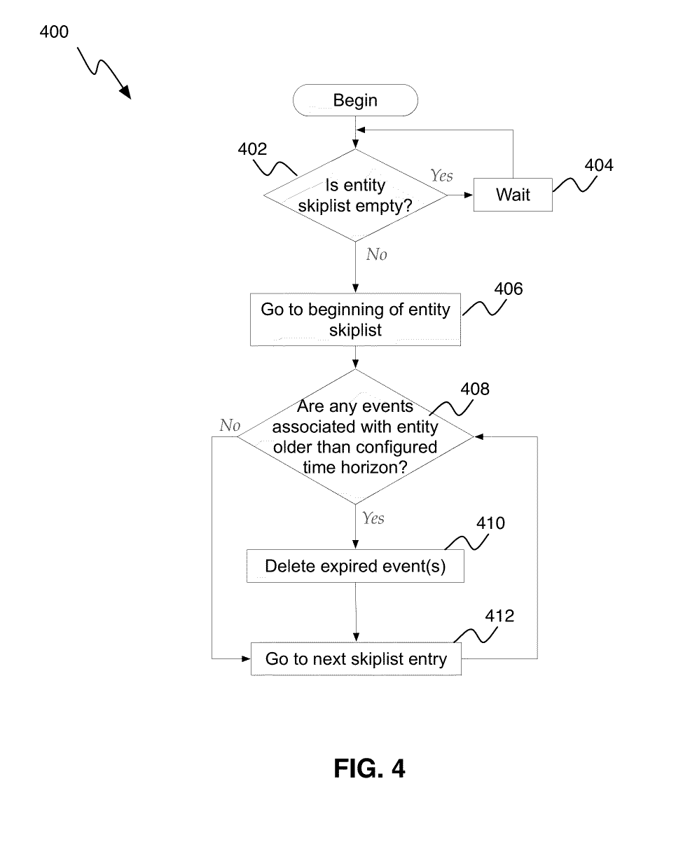

FIG. 4 shows a thread or process (400) for deleting expired events in accordance with one embodiment. The thread or process (400) runs continuously and accesses the entity and bit vector skiplists of FIG. 3. As can be seen in FIG. 4, the process (400) starts by examining whether the entity skiplist is empty (step 402). If the entity skiplist is empty, the thread waits (step 404) until the entity skiplist is no longer empty, at which point it goes to the beginning of the entity skiplist (step 406). Next, the thread examines whether there are any events associated with the entity that are older than the configured time horizon (step 408). If there are such expired events, the thread deletes them from their respective queues and deletes entries on the bit vector skiplist corresponding to those expired events (step 410). If there are no events older than the configured time horizon, or once the expired events and bit vectors have been deleted in step 410, the process moves on to the next skiplist entry (step 412), and then returns to step 408. This ongoing process continues in parallel with the path detection process of FIG. 3 until the path detector is stopped.

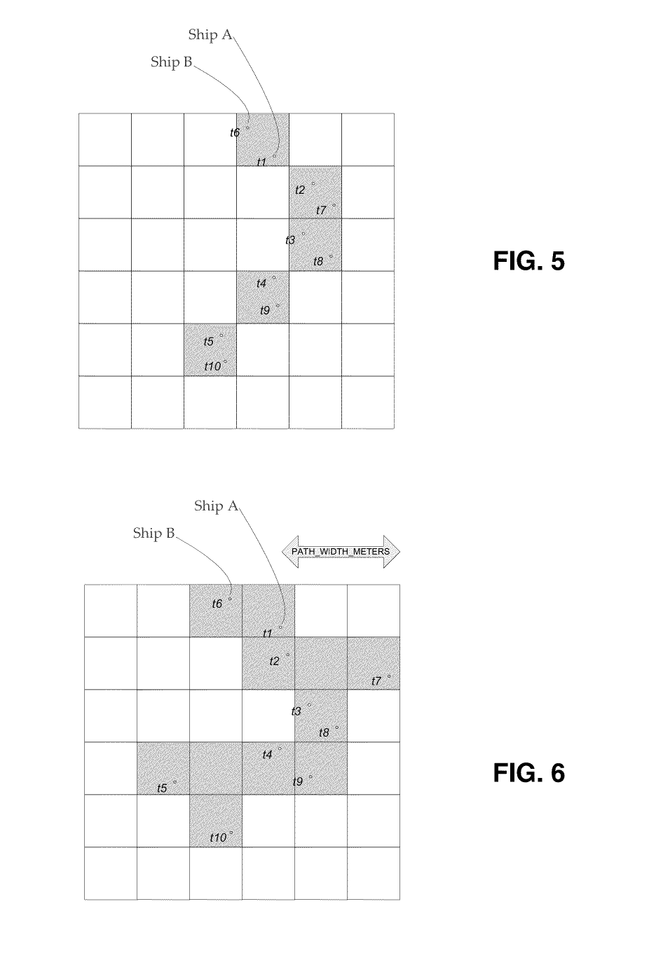

FIG. 5 schematically shows a grid of STBs and how a path can be detected when two entities (i.e., Ship A and Ship B) traverse the same STBs in the same sequence. That is, the shaded STBs in FIG. 5 become part of the path.

FIG. 6 schematically shows a grid of STBs and how a path can be detected when multiple entities (again Ship A and Ship B) traverse within PATH_WIDTH_METERS of each other, in the same sequence. Here the path width corresponds to roughly two STB widths. Intervening STBs in which no entities are observed (e.g., the STB between Ship A at time t2 and Ship B at time t7) may or may not be included in the path depending on the configuration settings.

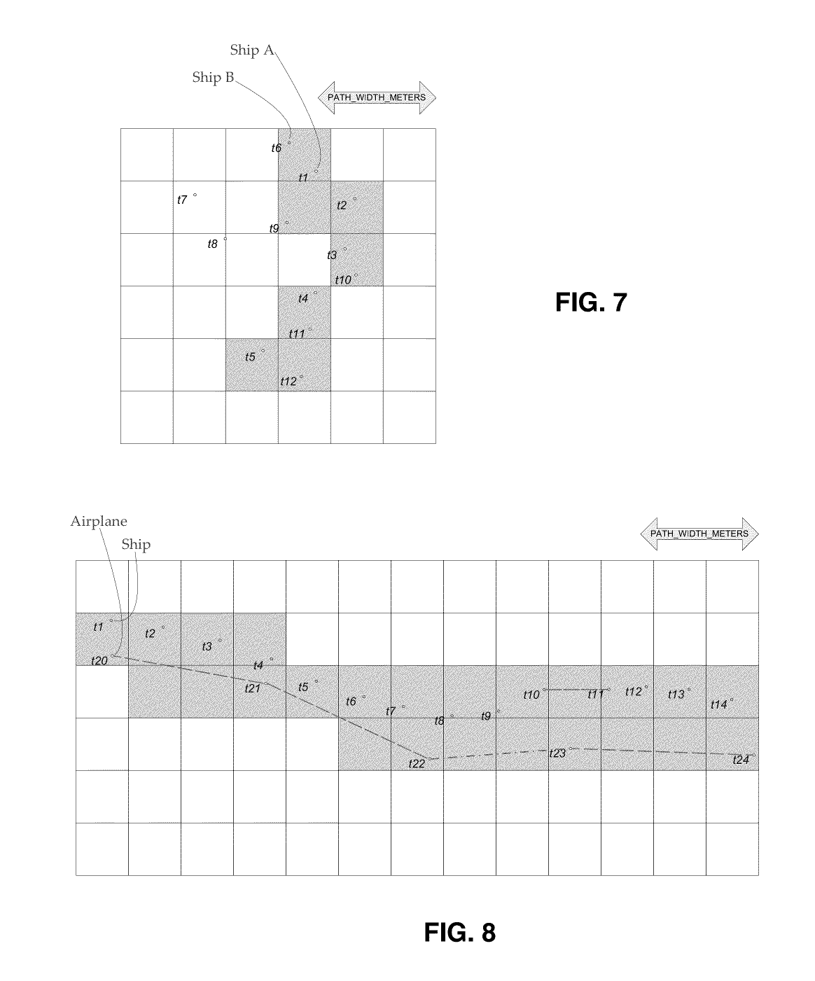

FIG. 7 schematically shows how a path may optionally be detected when an entity meanders from the path of other entities then returns to the path common with those other entities (i.e., back to within PATH_WIDTH_METERS of those entities.

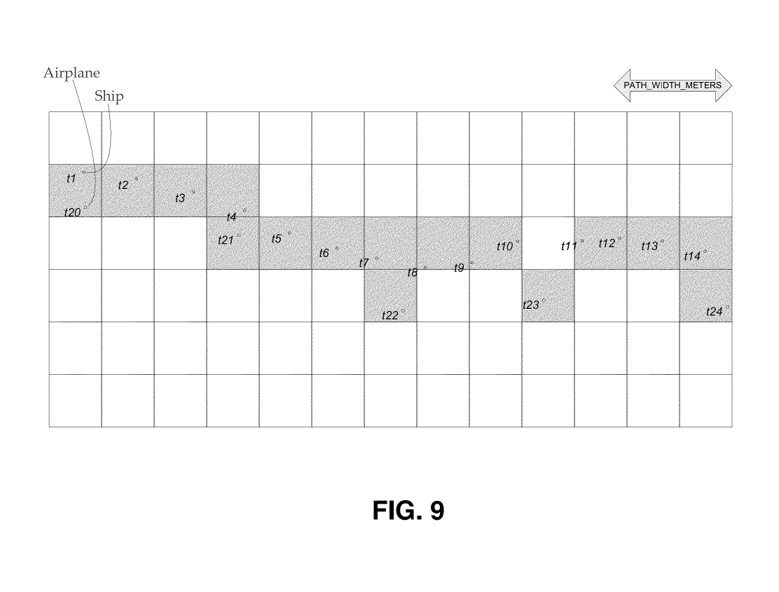

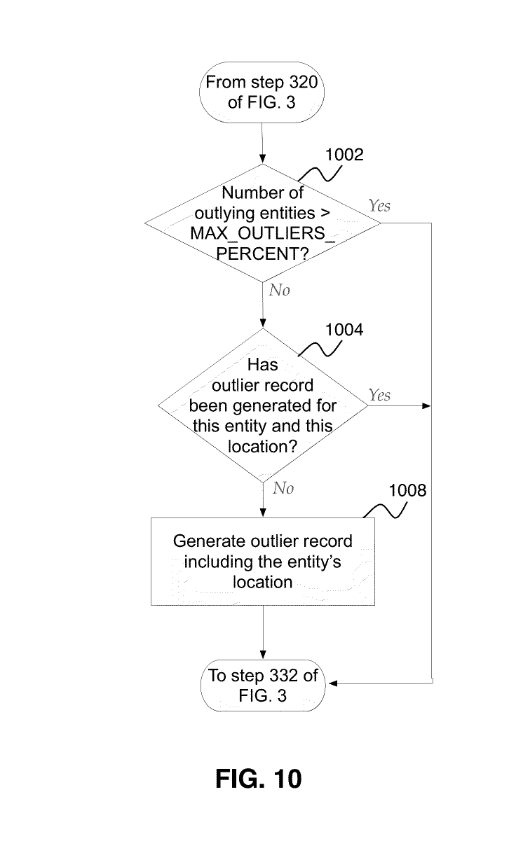

FIGS. 8 and 9 schematically show what happens when entities skip across STBs between observations. As can be seen in FIG. 8, the Ship has many more observations than the Airplane, which skips many STBs. In one embodiment, as shown in FIG. 8, a straight line is extrapolated between the spatial quanta in which the entity is observed. For example, the STB between the observations at time t10 and t11 might be included on the path of the Ship, in this example.

By the same token an entity that skips many STBs—either because entity moves relatively fast compared to other entities, or because the entity is observed less frequently than the other entities, might be found to follow a path by comparing it sequentially with the entities that are observed in relatively more STBs, as shown in FIG. 8.

Alternatively, as described above, in some embodiments the path might include just those STBs in which entities are observed following a common sequence, as shown in FIG. 9.

The flowchart and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer-implemented method for processing motion paths for physical entities, comprising:
for each physical entity among a plurality of physical entities, receiving a plurality of representations of positions of the physical entity;
in response to detecting that a number of physical entities among the plurality of physical entities traverse a similar motion path, generating a path record representing the motion path traversed by the number of physical entities.

2. The method of claim 1, further comprising:
in response to detecting that a first different physical entity among the plurality of physical entities traverse a motion path that is different from the motion path represented by the path record, generating an alternate path record representing the alternate motion path traversed by the first different physical entity.

3. The method of claim 1, wherein the motion path represents the motion of the number of physical entities over time and wherein the path record is represented as a series of quantized spacetime regions.

4. The method of claim 1, wherein the receiving and generating steps occur in real time as representations of positions are received.

5. The method of claim 1, further comprising:
detecting whether the generated motion path changes over time; and
in response to detecting that the generated motion path changes over time, adjusting the path record to create an adjusted path record representing a changed motion path traversed by the number of physical entities.

6. The method of claim 3, wherein a size of the quantized spacetime regions is configurable by a user.

7. The method of claim 3, wherein spatial components of the quantized spacetime regions are represented as bit vectors and the motion path is represented as a series of bit vectors representing contiguous spatial regions.

8. The method of claim 3, wherein temporal components of the quantized spacetime regions are represented as sets of numeric values that can represent one or more of: a year, a month, a day, an hour, a minute, a second, and a millisecond.

9. The method of claim 1, further comprising:
averaging several path records to detect whether physical entities observed to traverse nearby paths are traversing a common path.

10. The method of claim 1, further comprising:
reporting the detected motion path to an entity analytics or entity relationship detection engine.

11. The method of claim 2, further comprising:
reporting the detected alternate motion path to an entity analytics or entity relationship detection engine.
